(19) United States
(12) Patent Application Publication
(10) Pub. No.: US 2024/0303456 A1
(43) Pub. Date: Sep. 12, 2024

(54) SYSTEMS AND METHODS FOR STEGANOGRAPHIC IMAGE ENCODING AND IDENTITY VERIFICATION USING SAME

(71) Applicant: Capital One Services, LLC, McLean, VA (US)

(72) Inventors: Kevin OSBORN, Newton Highlands, MA (US); Jeffrey RULE, Chevy Chase, MD (US)

(21) Appl. No.: 18/118,667

(22) Filed: Mar. 7, 2023

(51) Int. Cl. G06K 19/073

(52) U.S. Cl. CPC G06K 19/07354

(57) ABSTRACT

A card, system, and method for validating a user's identity with card image steganography are provided. The system includes a card, a user device, and a processor. The card comprises a face with a steganographic pattern encrypted onto its substrate. The processor is configured to receive a request associated with the card, recognize the biometric data from the steganographic pattern on the card, and verify the user's identity by matching the user's biometric to the card's biometric.

### FIELD OF DISCLOSURE

The present disclosure relates to systems and methods for the generation and use of encoded steganographic patterns to verify biometric information associated with a user.

### BACKGROUND

Many card-based transactions require users to verify their identity. Some forms of verification include password requirements, personal identification numbers (PINs), or two factor authentications. These aforementioned methods provide some security, but they are prone to risks such as hacking. Another risk includes a user forgetting their password or otherwise losing access to one of the factors necessary for multi-factor authentication.

For high-risk transactions, a greater level of security is needed. A safer way to verify a user's identity is through biometrics. Biometrics are information associated with human body measurements and physical characteristics. Some examples of biometrics are fingerprints and facial composition. Biometrics are a more secure way of protecting a user's information because a biometric is one-of-a-kind and cannot be forgotten or lost like a password.

However, biometrics are difficult to implement onto cards. Therefore, there is an unmet need for a way to put a biometric information onto a card.

### SUMMARY OF THE DISCLOSURE

Example embodiments of the present disclosure provide systems and methods for providing a steganographic pattern containing biometric information onto a card.

Generally, the systems and methods comprise a steganographically encoded card and a user device. The card contains a steganographic pattern encoded on the substrate of the card. The steganographic pattern contains an encryption of a user's biometric data. The biometric data can include facial patterns, fingerprints, or other kinds of biometrics.

Embodiments of the present disclosure provide a card configured to contain biometric information. The card comprises a substrate and a first face. The first face comprises an encoded steganographic pattern containing biometric data associated with a user.

Embodiments of the present disclosure provide a system for identify verification. The system comprises a card, a user device, and a processor. The card comprises a substrate and a first face. The first face comprises an encoded steganographic pattern containing biometric data associated with a user. The processor is configured to perform the following steps: receive a request associated with the card; recognize the biometric data from the steganographic pattern on the card; request verification biometric data from the user associated with the card; receive, by the user device, verification biometric data from the user; and apply an algorithm to determine whether the verification biometric data matches the biometric data contained in the steganographic pattern.

Embodiments of the present disclosure provide a method for identity verification. The method comprises the following steps: providing a card configured to contain biometric information, the card comprising a substrate and a first face further comprising a steganographic pattern containing data associated with a user; receiving, by a user device, a request associated with the card; recognizing, by the user device, the biometric data from the steganographic pattern on the card; requesting, by the user device, verification biometric data from the user associated with the card; receiving, by the user device, verification biometric data from the user; and applying, by the user device, an algorithm to determine verification biometric data matches the biometric data contained in the steganographic pattern.

### BRIEF DESCRIPTION OF THE DRAWINGS

FIG. 1 is a block diagram of a system according to an exemplary embodiment.

FIG. 2 is a diagram of a card containing steganographic information according to an exemplary embodiment.

FIG. 3 is a diagram of a card containing steganographic information according to an exemplary embodiment.

FIG. 4 is a diagram of steganographic applications according to an exemplary embodiment.

FIG. 5 is a block diagram of steganographic application according to an exemplary embodiment.

FIG. 6 is a method flowchart according to an exemplary embodiment.

FIG. 7 is a method flowchart according to an exemplary embodiment.

FIG. 8 is a diagram illustrating identity verification according to an exemplary embodiment.

### DETAILED DESCRIPTION

Exemplary embodiments of the invention will now be described in order to illustrate various features of the invention. The embodiments described herein are not intended to be limiting as to the scope of the invention, but rather are intended to provide examples of the components, use, and operation of the invention.

Furthermore, the described features, advantages, and characteristics of the embodiments may be combined in any suitable manner. One skilled in the relevant art will recognize that the embodiments may be practiced without one or more of the specific features or advantages of an embodiment. In other instances, additional features and advantages may be recognized in certain embodiments that may not be present in all embodiments. One skilled in the relevant art will recognize that the features, advantages, and characteristics any embodiment may be interchangeably combined with the features, advantages, and characteristics of any other embodiment.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Generally, example embodiments of the present disclosure describe systems and methods for verifying a user's identity with a steganographically encoded card. A user is provided with a card that has been steganographically encoded with a biometric—for example, a facial scan. If the user wants to perform a high risk transaction, the user can supply their card to a user device like an automated teller machine (ATM). The ATM scans the card and retrieves the facial scan from the card. To confirm the user's identity, the ATM photographs the user's face and matches it to the facial scan derived from the card. Once verified, the user proceeds with the transaction.

In other embodiments, the card can be encoded with a facial scan and/or other biometrics including, without limitation, fingerprints, writing samples, retinal scans, voice samples, a three-dimensional facial geometry, and any combination thereof. In other examples, non-biometric information can be encoded including, without limitation, passwords, passcodes, account information (e.g., account numbers, transaction history, a most recent transaction), and a user identification number or code. Furthermore, the user device can be an ATM, a smart phone, or another computer-enabled device. To verify their identity, the user may take a selfie on their smart phone or scan their fingerprint on a separate device. A user can employ these systems and methods to access secure areas like homes, secure containers, or other private areas.

Compared to conventional methods, these new systems and methods provide greater security to high risk transactions. Because biometrics are one-of-a-kind, they are less prone to hacking and imitation by outside parties. Additionally, biometrics are not able to be misplaced or forgotten like the conventional password or PIN number. But although biometrics are desirable, the average consumer would feel uncomfortable putting an image of their face or fingerprints on their credit card. Steganography avoids this discomfort. To the human eye, a steganographic pattern looks like a generic or random pattern of dots. Thus, steganography ensures that an outside party would have no idea that a user's card contains a biometric. This allows a user to benefit from the added security of a biometric without feeling the discomfort of displaying it on their card. Moreover, the user can enjoy more peace of mind knowing that their biometric information is not being stored on a third-party server. Their biometric is contained only on the face of the card, nowhere else. Thus, a user feels a greater sense of privacy.

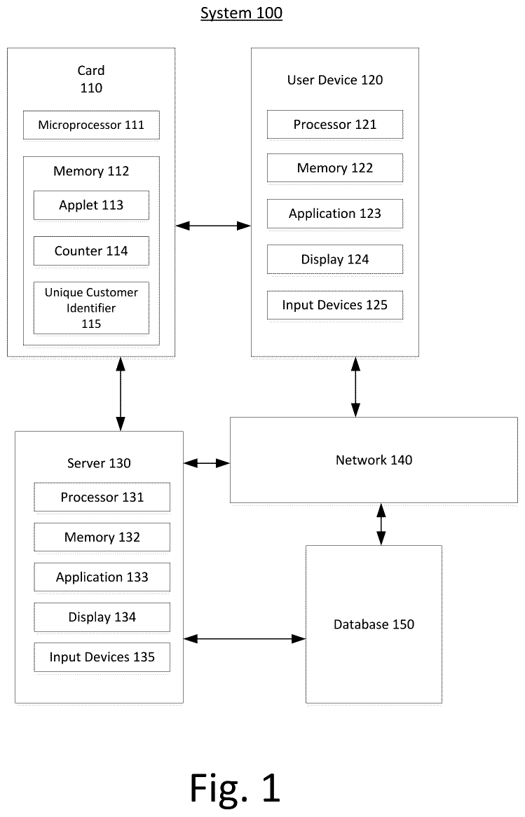

FIG. 1 is a block diagram of a system according to an exemplary embodiment.

FIG. 1 illustrates a system 100 according to an example embodiment. The system 100 may comprise a contactless card 110, a user device 120, a server 130, a network 140, and a database 150. Although FIG. 1 illustrates single instances of components of system 100, system 100 may include any number of components.

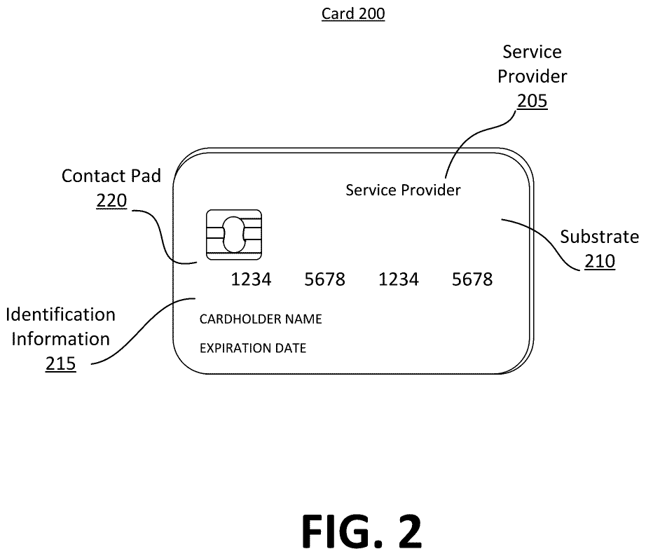

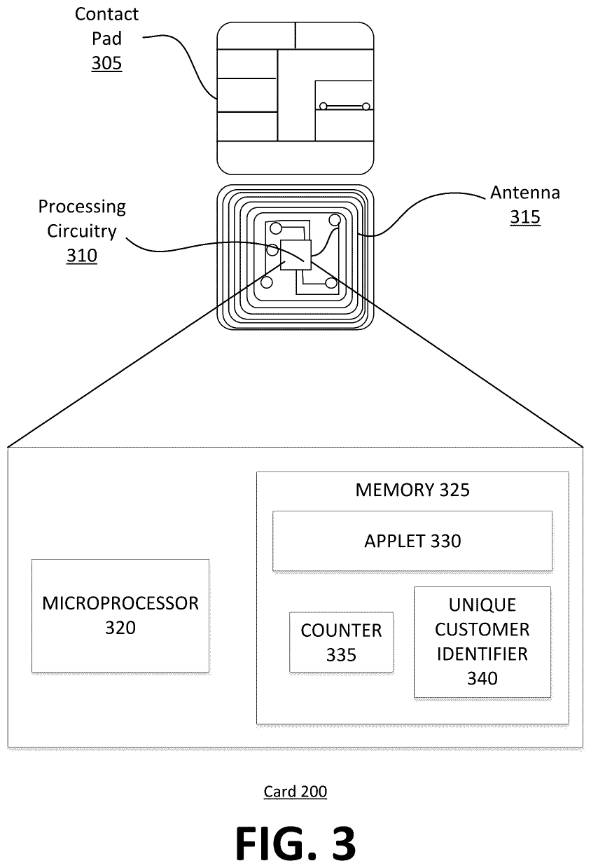

System 100 may include one or more contactless cards 110 which are further explained below with reference to FIG. 2 and FIG. 3. In some embodiments, contactless card 110 may be in wireless communication, utilizing NFC in an example, with user device 120.

System 100 may include a user device 120. The user device 120 may be a network-enabled computer device. Exemplary network-enabled computer devices include, without limitation, a server, a network appliance, a personal computer, a workstation, a phone, a handheld personal computer, a personal digital assistant, a thin client, a fat client, an Internet browser, a mobile device, a kiosk, a contactless card, an automatic teller machine (ATM), or other a computer device or communications device. For example, network-enabled computer devices may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The user device 120 may include a processor 121, a memory 122, and an application 123. The processor 121 may be a processor, a microprocessor, or other processor, and the user device 120 may include one or more of these processors. The processor 121 may include processing circuitry, which may contain additional components, including additional processors, memories, error and parity/CRC checkers, data encoders, anti-collision algorithms, controllers, command decoders, security primitives and tamper-proofing hardware, as necessary to perform the functions described herein.

The processor 121 may be coupled to the memory 122. The memory 122 may be a read-only memory, write-once read-multiple memory or read/write memory, e.g., RAM, ROM, and EEPROM, and the user device 120 may include one or more of these memories. A read-only memory may be factory programmable as read-only or one-time programmable. One-time programmability provides the opportunity to write once then read many times. A write-once read-multiple memory may be programmed at a point in time after the memory chip has left the factory. Once the memory is programmed, it may not be rewritten, but it may be read many times. A read/write memory may be programmed and re-programed many times after leaving the factory. It may also be read many times. The memory 122 may be configured to store one or more software applications, such as the application 123, and other data, such as user's private data and financial account information.

The application 123 may comprise one or more software applications, such as a mobile application and a web browser, comprising instructions for execution on the user device 120. In some examples, the user device 120 may execute one or more applications, such as software applications, that enable, for example, network communications with one or more components of the system 100, transmit and/or receive data, and perform the functions described herein. Upon execution by the processor 121, the application 123 may provide the functions described in this specification, specifically to execute and perform the steps and functions in the process flows described below. Such processes may be implemented in software, such as software modules, for execution by computers or other machines. The application 123 may provide graphical user interfaces (GUIs) through which a user may view and interact with other components and devices within the system 100. The GUIs may be formatted, for example, as web pages in HyperText Markup Language (HTML), Extensible Markup Language (XML) or in any other suitable form for presentation on a display device depending upon applications used by users to interact with the system 100.

The user device 120 may further include a display 124 and input devices 125. The display 124 may be any type of device for presenting visual information such as a computer monitor, a flat panel display, and a mobile device screen, including liquid crystal displays, light-emitting diode displays, plasma panels, and cathode ray tube displays. The input devices 125 may include any device for entering information into the user device 120 that is available and supported by the user device 120, such as a touch-screen, keyboard, mouse, cursor-control device, touch-screen, microphone, digital camera, video recorder or camcorder. These devices may be used to enter information and interact with the software and other devices described herein.

System 100 may include a server 130. The server 130 may be a network-enabled computer device. Exemplary network-enabled computer devices include, without limitation, a server, a network appliance, a personal computer, a workstation, a phone, a handheld personal computer, a personal digital assistant, a thin client, a fat client, an Internet browser, a mobile device, a kiosk, a contactless card, or other a computer device or communications device. For example, network-enabled computer devices may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The server 130 may include a processor 131, a memory 132, and an application 133. The processor 131 may be a processor, a microprocessor, or other processor, and the server 130 may include one or more of these processors. The processor 131 may include processing circuitry, which may contain additional components, including additional processors, memories, error and parity/CRC checkers, data encoders, anti-collision algorithms, controllers, command decoders, security primitives and tamper-proofing hardware, as necessary to perform the functions described herein.

The processor 131 may be coupled to the memory 132. The memory 132 may be a read-only memory, write-once read-multiple memory or read/write memory, e.g., RAM, ROM, and EEPROM, and the server 130 may include one or more of these memories. A read-only memory may be factory programmable as read-only or one-time programmable. One-time programmability provides the opportunity to write once then read many times. A write-once read-multiple memory may be programmed at a point in time after the memory chip has left the factory. Once the memory is programmed, it may not be rewritten, but it may be read many times. A read/write memory may be programmed and re-programed many times after leaving the factory. It may also be read many times. The memory 132 may be configured to store one or more software applications, such as the application 133, and other data, such as user's private data and financial account information.

The application 133 may comprise one or more software applications comprising instructions for execution on the server 130. In some examples, the server 130 may execute one or more applications, such as software applications, that enable, for example, network communications with one or more components of the system 100, transmit and/or receive data, and perform the functions described herein. Upon execution by the processor 131, the application 133 may provide the functions described in this specification, specifically to execute and perform the steps and functions in the process flows described below. For example, the application 133 may be executed to perform receiving web form data from the user device 120 and the card 110, retaining a web session between the user device 120 and the card 110, and masking private data received from the user device 120 and the card 110. Such processes may be implemented in software, such as software modules, for execution by computers or other machines. The application 133 may provide GUIs through which a user may view and interact with other components and devices within the system 100. The GUIs may be formatted, for example, as web pages in HyperText Markup Language (HTML), Extensible Markup Language (XML) or in any other suitable form for presentation on a display device depending upon applications used by users to interact with the system 100.

The server 130 may further include a display 134 and input devices 135. The display 134 may be any type of device for presenting visual information such as a computer monitor, a flat panel display, and a mobile device screen, including liquid crystal displays, light-emitting diode displays, plasma panels, and cathode ray tube displays. The input devices 135 may include any device for entering information into the server 130 that is available and supported by the server 130, such as a touch-screen, keyboard, mouse, cursor-control device, touch-screen, microphone, digital camera, video recorder or camcorder. These devices may be used to enter information and interact with the software and other devices described herein.

System 100 may include one or more networks 140. In some examples, the network 140 may be one or more of a wireless network, a wired network or any combination of wireless network and wired network, and may be configured to connect the user device 120, the server 130, the database 150 and the card 110. For example, the network 140 may include one or more of a fiber optics network, a passive optical network, a cable network, an Internet network, a satellite network, a wireless local area network (LAN), a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11b, 802.15.1, 802.11n and 802.11g, Bluetooth, NFC, Radio Frequency Identification (RFID), Wi-Fi, and/or the like.

In addition, the network 140 may include, without limitation, telephone lines, fiber optics, IEEE Ethernet 902.3, a wide area network, a wireless personal area network, a LAN, or a global network such as the Internet. In addition, the network 140 may support an Internet network, a wireless communication network, a cellular network, or the like, or any combination thereof. The network 140 may further include one network, or any number of the exemplary types of networks mentioned above, operating as a stand-alone network or in cooperation with each other. The network 140 may utilize one or more protocols of one or more network elements to which they are communicatively coupled. The network 140 may translate to or from other protocols to one or more protocols of network devices. Although the network 140 is depicted as a single network, it should be appreciated that according to one or more examples, the network 140 may comprise a plurality of interconnected networks, such as, for example, the Internet, a service provider's network, a cable television network, corporate networks, such as credit card association networks, and home networks. The network 140 may further comprise, or be configured to create, one or more front channels, which may be publicly accessible and through which communications may be observable, and one or more secured back channels, which may not be publicly accessible and through which communications may not be observable.

System 100 may include a database 150. The database 150 may be one or more databases configured to store data, including without limitation, private data of users, financial accounts of users, identities of users, transactions of users, and certified and uncertified documents. The database 150 may comprise a relational database, a non-relational database, or other database implementations, and any combination thereof, including a plurality of relational databases and non-relational databases. In some examples, the database 150 may comprise a desktop database, a mobile database, or an in-memory database. Further, the database 150 may be hosted internally by the server 130 or may be hosted externally of the server 130, such as by a server, by a cloud-based platform, or in any storage device that is in data communication with the server 130.

In some examples, exemplary procedures in accordance with the present disclosure described herein can be performed by a processing arrangement and/or a computing arrangement (e.g., computer hardware arrangement). Such processing/computing arrangement can be, for example entirely or a part of, or include, but not limited to, a computer/processor that can include, for example one or more microprocessors, and use instructions stored on a non-transitory computer-accessible medium (e.g., RAM, ROM, hard drive, or other storage device). For example, a computer-accessible medium can be part of the memory of the contactless card 110, the user device 120, the server 130, the network 140, and the database 150 or other computer hardware arrangement.

In some examples, a computer-accessible medium (e.g., as described herein, a storage device such as a hard disk, floppy disk, memory stick, CD-ROM, RAM, ROM, etc., or a collection thereof) can be provided (e.g., in communication with the processing arrangement). The computer-accessible medium can contain executable instructions thereon. In addition or alternatively, a storage arrangement can be provided separately from the computer-accessible medium, which can provide the instructions to the processing arrangement so as to configure the processing arrangement to execute certain exemplary procedures, processes, and methods, as described herein above, for example.

FIG. 2 is a diagram of a card containing steganographic information according to an exemplary embodiment.

FIG. 2 illustrates a contactless card 200 according to an example embodiment. The contactless card 200 may comprise a payment card, such as a credit card, debit card, or gift card, issued by a service provider 205 displayed on the front or back of the card 200. In some examples, the payment card may comprise a dual interface contactless payment card. In some examples, the contactless card 200 is not related to a payment card, and may comprise, without limitation, an identification card, a membership card, a loyalty card, a transportation card, and a point of access card.

The contactless card 200 may comprise a substrate 210, which may include a single layer or one or more laminated layers composed of plastics, metals, and other materials. Exemplary substrate materials include polyvinyl chloride, polyvinyl chloride acetate, acrylonitrile butadiene styrene, polycarbonate, polyesters, anodized titanium, palladium, gold, carbon, paper, and biodegradable materials. In some examples, the contactless card 200 may have physical characteristics compliant with the ID-1 format of the ISO/IEC 7810 standard, and the contactless card may otherwise be compliant with the ISO/IEC 14443 standard. However, it is understood that the contactless card 200 according to the present disclosure may have different characteristics, and the present disclosure does not require a contactless card to be implemented in a payment card.

The contactless card 200 may also include identification information 215 displayed on the front and/or back of the card, and a contact pad 220. The contact pad 220 may be configured to establish contact with another communication device, such as a user device, smart phone, laptop, desktop, or tablet computer. The contactless card 200 may also include processing circuitry, antenna and other components not shown in FIG. 2 and FIG. 3. These components may be located behind the contact pad 220 or elsewhere on the substrate 210. The contactless card 200 may also include a magnetic strip or tape, which may be located on the back of the card (not shown in FIG. 2).

FIG. 3 illustrates a contactless card 200 according to an example embodiment.

As illustrated in FIG. 3, the contact pad 305 may include processing circuitry 310 for storing and processing information, including a microprocessor 320 and a memory 325. It is understood that the processing circuitry 310 may contain additional components, including processors, memories, error and parity/CRC checkers, data encoders, anticollision algorithms, controllers, command decoders, security primitives and tamperproofing hardware, as necessary to perform the functions described herein.

The memory 325 may be a read-only memory, write-once read-multiple memory or read/write memory, e.g., RAM, ROM, and EEPROM, and the contactless card 200 may include one or more of these memories. A read-only memory may be factory programmable as read-only or one-time programmable. One-time programmability provides the opportunity to write once then read many times. A write once/read-multiple memory may be programmed at a point in time after the memory chip has left the factory. Once the memory is programmed, it may not be rewritten, but it may be read many times. A read/write memory may be programmed and re-programed many times after leaving the factory. It may also be read many times.

The memory 325 may be configured to store one or more applets 330, one or more counters 335, and a customer identifier 340. The one or more applets 330 may comprise one or more software applications configured to execute on one or more contactless cards, such as Java Card applet. However, it is understood that applets 330 are not limited to Java Card applets, and instead may be any software application operable on contactless cards or other devices having limited memory. The one or more counters 335 may comprise a numeric counter sufficient to store an integer. The customer identifier 340 may comprise a unique alphanumeric identifier assigned to a user of the contactless card 200, and the identifier may distinguish the user of the contactless card from other contactless card users. In some examples, the customer identifier 340 may identify both a customer and an account assigned to that customer and may further identify the contactless card associated with the customer's account.

The processor and memory elements of the foregoing exemplary embodiments are described with reference to the contact pad, but the present disclosure is not limited thereto. It is understood that these elements may be implemented outside of the pad 305 or entirely separate from it, or as further elements in addition to processor 320 and memory 325 elements located within the contact pad 305.

In some examples, the contactless card 200 may comprise one or more antennas 315. The one or more antennas 315 may be placed within the contactless card 200 and around the processing circuitry 310 of the contact pad 305. For example, the one or more antennas 315 may be integral with the processing circuitry 310 and the one or more antennas 315 may be used with an external booster coil. As another example, the one or more antennas 315 may be external to the contact pad 305 and the processing circuitry 310.

In an embodiment, the coil of contactless card 200 may act as the secondary of an air core transformer. The terminal may communicate with the contactless card 200 by cutting power or amplitude modulation. The contactless card 200 may infer the data transmitted from the terminal using the gaps in the contactless card's power connection, which may be functionally maintained through one or more capacitors. The contactless card 200 may communicate back by switching a load on the contactless card's coil or load modulation. Load modulation may be detected in the terminal's coil through interference.

As explained above, the contactless cards 200 may be built on a software platform operable on smart cards or other devices having limited memory, such as JavaCard, and one or more or more applications or applets may be securely executed. Applets may be added to contactless cards to provide a one-time password (OTP) for multifactor authentication (MFA) in various mobile application-based use cases. Applets may be configured to respond to one or more requests, such as near field data exchange requests, from a reader, such as a mobile NFC reader, and produce an NDEF message that comprises a cryptographically secure OTP encoded as an NDEF text tag.

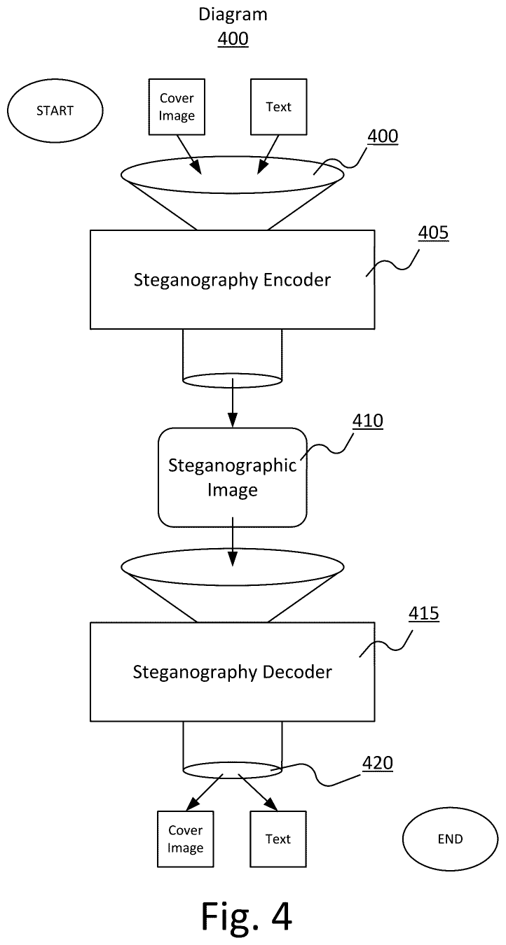

FIG. 4 is a block diagram illustrating the general process of steganography.

Generally, steganography is the hiding of information in a visual image. The information can be called the text. The visual image can be called the cover image. Through one or more methods of steganography, the text can be hidden in and among the cover images. Importantly, steganography can hide the text among the cover image so well that an unaided observer cannot tell that the cover image has been altered let alone what the text is. The purpose of steganography is provided two or more parties the ability to share information securely. That is, a transmitting party can send a cover image to a receiving party. The cover image contains some text that has been steganographically encrypted into it. The receiving party receives the cover image and, knowing that the cover image contains a message, decodes the text with a predetermined algorithm.

FIG. 4 describes a general, non-limiting example of a steganographic process.

The process can begin with action 400. In action 400, the user chooses a text and a cover image. The text can include any kind of data including financial information, personal identity information, or one or more messages. The cover image can include any visual image including a jpeg, pdf, photograph, film, or any other visual representation. Generally, the user wants the text to be hidden steganographically within the cover image.

Next, in action 405 a steganography encoder embeds the text within the cover image. The steganography encoder can employ one or more steganographic methods including batch steganography, permutation steganography, least significant bits (LSB), bit-plane complexity segmentation (BPCS), chaos based spread spectrum image steganography (CSSIS), masking and filtering, redundant pattern encoding, encrypt and scatter, chaffing and winnowing, and coding and cosine transformation. The algorithm can be run on a processor. The processor may be a part of a user device or a server.

In action 410, the steganographic encoder creates the steganographic image or steganographic object. The steganographic image is the result of embedding the text in the cover image. Generally, the steganographic image is configured such that an oblivious third party cannot tell that there is any text hidden among the cover images. Having created the steganographic image, a transmitting party may want to send the image to a receiving party for the purpose of sharing secret information.

In action 415, the steganographic image can be fed into a steganographic decoder. The steganographic decoder can be a similar algorithm used in action 405. The steganography decoder can employ one or more steganographic methods including batch steganography, permutation steganography, least significant bits (LSB), bit-plane complexity segmentation (BPCS), chaos based spread spectrum image steganography (CSSIS), masking and filtering, redundant pattern encoding, encrypt and scatter, and coding and cosine transformation. The algorithm can be run on a processor. The processor may be a part of a user device or a server.

In action 420, the steganographic decoder distinguishes between the cover image and the text. A receiving party may now process the text that was hidden among the cover images. The process of steganography does not require cryptography. However, the steganographic process can be made more secure by the application of an encryption algorithm. An encryption algorithm may be used to encrypt the text before being encoded into the steganographic image. Likewise, a decryption algorithm may be used to decrypt the text once the text has been decoded from the steganographic image. In effect, the addition of cryptography adds a second level of authentication needed to read the secret text.

In some examples, the text can be encrypted using symmetric encryption with diversified keys, where each party to the transmissions can be provided with a master key and/or diversified keys based on the master key. In other examples, public key/private key encryption can be implemented.

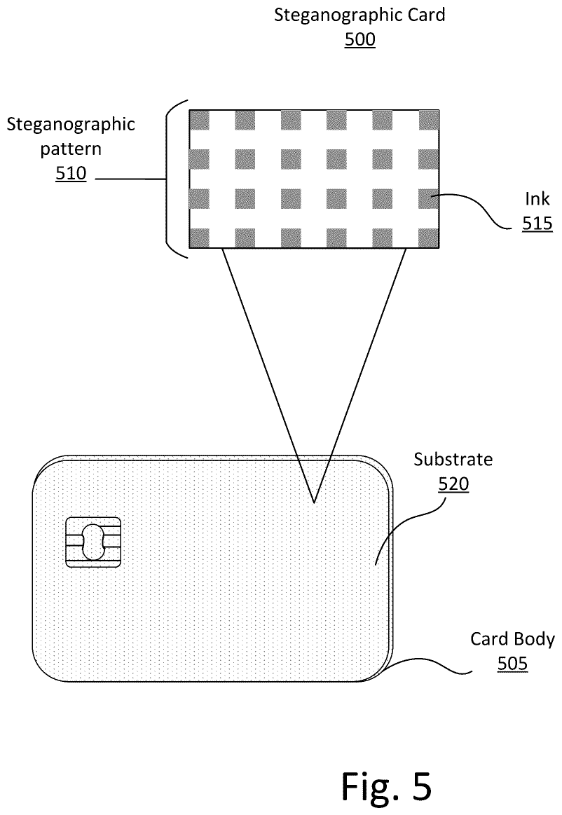

FIG. 5 is a diagram describing a card with a steganographic pattern on the substrate. This can be called a steganographic card 500.

The steganographic card 500 can comprise a body 505, a steganographic pattern 510, an ink 515, and a substrate 520.

The body 505 may be comprised of a durable material, including but not limited to plastic such as polyvinyl chloride (PVC), polyvinyl chloride acetate, acrylonitrile butadiene styrene, polycarbonate, polyesters, and metal such as brass, copper, brushed stainless steel, titanium, gold or palladium. It is understood that these examples are non-limiting and that other material and combinations thereof may constitute the body 505.

The body 505 may have a first face having a substrate 520. The substrate 520 may include a single layer or one or more laminated layers composed of plastics, metals, and other materials. Exemplary substrate materials include polyvinyl chloride, polyvinyl chloride acetate, acrylonitrile butadiene styrene, polycarbonate, polyesters, anodized titanium, palladium, gold, carbon, paper, and biodegradable materials. It is understood that these examples are non-limiting and that other material and combinations thereof may constitute the substrate 210.

The substrate 210 may comprise a steganographic pattern 510. The steganographic pattern 510 may be completed by substitution methods, transform domain techniques, spread spectrum techniques, statistical methods, and distortion techniques. Substitution methods substitute redundant parts of a cover with a secret message. Transform domain techniques embed secret information in a transform space to the signal. Spread spectrum techniques adopt ideas from spread spectrum communication. Statistical methods encode information by changing several statistical properties of a cover image and use hypothesis testing in the extraction process. Distortion techniques store information by signal distortion and measure the deviation from the original cover in the decoding step. It is understood that these examples are non-limiting and that other combinations thereof may constitute the steganographic pattern 510.

Although the steganographic pattern 510 is represented as an ordered matrix of ink squares, it is understood that this is just one example of how the steganographic pattern can be configured. The steganographic pattern 510 may comprise an unordered matrix of pixels, a watermark, or some other pattern.

The steganographic pattern 510 may comprise an ink 515. The ink 515 may comprise reflective ink, UV sensitive ink, temperature sensitive ink, or magnetic ink. It is understood that these examples are non-limiting and that other material and combinations thereof may constitute the ink 515.

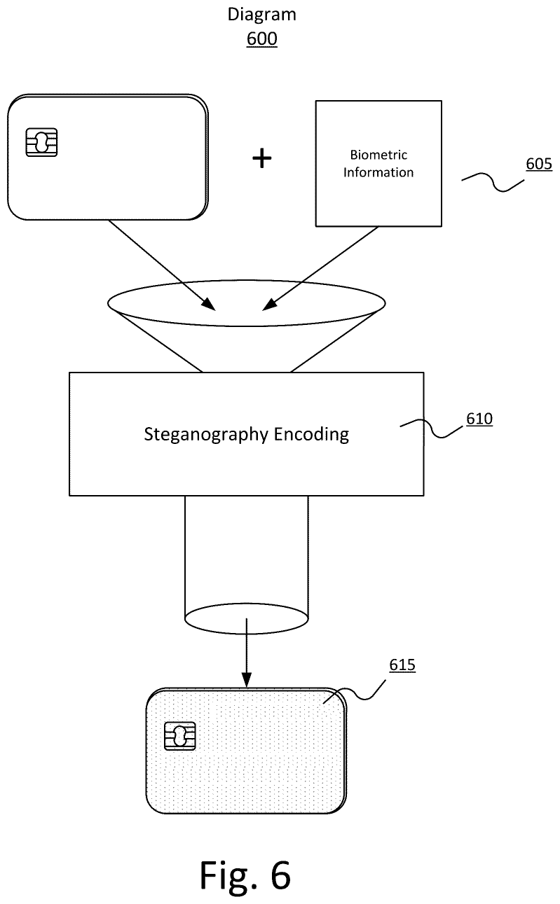

FIG. 6 is a diagram according to an exemplary embodiment.

In actions 605 and 610, biometric information is steganographically encoded onto a card. The card may be comprised of polyvinyl chloride, polyvinyl chloride acetate, acrylonitrile butadiene styrene, polycarbonate, polyesters, anodized titanium, palladium, gold, carbon, paper, and biodegradable materials. The biometric information can include facial scans, iris scans, fingerprint scans, a scalable ratio of facial features associated with the user, hand scans, voice recognitions, and handwriting recognitions. Generally, the biometric information is associated with one or more users.

The steganographic encoding 610 can employ one or more steganographic methods including batch steganography, permutation steganography, least significant bits (LSB), bit-plane complexity segmentation (BPCS), chaos based spread spectrum image steganography (CSSIS), masking and filtering, redundant pattern encoding, encrypt and scatter, and coding and cosine transformation. The algorithm can be run on a processor. The processor can be a part of the user device or a server.

In action 615, the steganographically patterned card is provided. The biometric information can be steganographically encoded onto the substrate 520 of the card. The steganographic pattern 510 may be encoded onto one or more faces of the card.

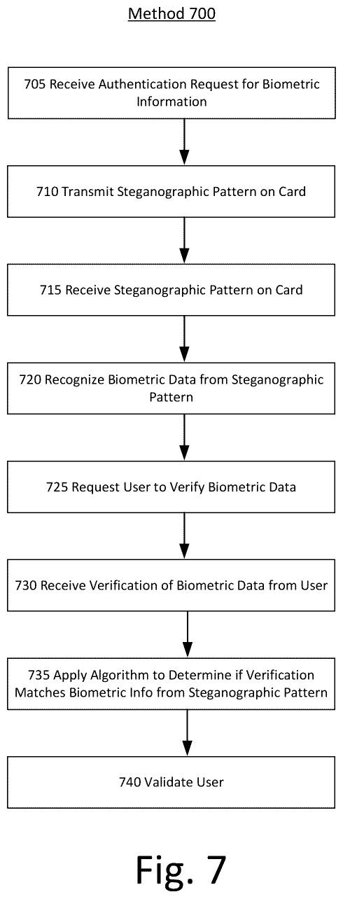

FIG. 7 is a diagram according to an example embodiment.

The method 700 operates on the assumption that there is a user, a user device, a processor, and a steganographic card.

The method 700 can being with step 705. In step 705, the processor receives an authentication request for biometric information. The processor may be a part of the user device or a server. The authentication request may be sent over a network.

In step 710, the user transmits the steganographic pattern on the card to the user device. This transmission can occur by inserting the card into the user device. As another example, the user may take scan the card and upload the scan to the user device. As another example, the card may employ a contactless communication with the user device through near field communication (NFC), Bluetooth, or other close field communication. The transmission may be completed by a processor. The processor may be a part of the user device or a server. The steganographic pattern may be sent over a network.

In step 715, the processor receives the steganographic pattern on the card. The processor may be a part of the user device or a server.

In step 720, the processor recognizes the biometric data from the steganographic pattern on the card. The processor may be a part of the user device or a server. In order to recognize the biometric data, the processor may use a predetermined algorithm configured with at least one selected from the group of batch steganography, permutation steganography, least significant bits (LSB), bit-plane complexity segmentation (BPCS), and chaos based spread spectrum image steganography (CSSIS).

The biometric data contained in the steganographic pattern may comprise facial scans, iris scans, fingerprint scans, a scalable ratio of facial features associated with the user, hand scans, voice recognitions, and handwriting recognitions.

In step 725, the processor requests the user to verify biometric data. The processor may be a part of the user device or a server. The processor may transmit the request to the user device or over the network to some other device. The user device may display the request on the display.

In step 730, the processor receives the user's verification of biometric data. For example, the user may take a selfie to verify a facial scan embedded in the steganographic pattern. The user may verify their biometric for other biometrics including iris scans, fingerprint scans, a scalable ratio of facial features associated with the user, hand scans, voice recognitions, and handwriting recognitions. The user may send these verifications to the processor or otherwise over the network. The processor may be a part of the user device or a server.

In step 735, the processor can apply a predetermined decoder algorithm to determine if the user's verification matches the biometric information recognized from the steganographic pattern in step. The decoder algorithm can be one or more selected from the group of batch steganography, permutation steganography, least significant bits (LSB), bit-plane complexity segmentation (BPCS), and chaos based spread spectrum image steganography (CSSIS), masking and filtering, redundant pattern encoding, encrypt and scatter, and coding and cosine transformation.

In step 740, the processor validates the user's identity and allows the transaction to proceed. The transactions can include financial transactions such as withdrawals and deposits, security transactions such as opening a safe or locked door, or any other transactions requiring security or identity verification.

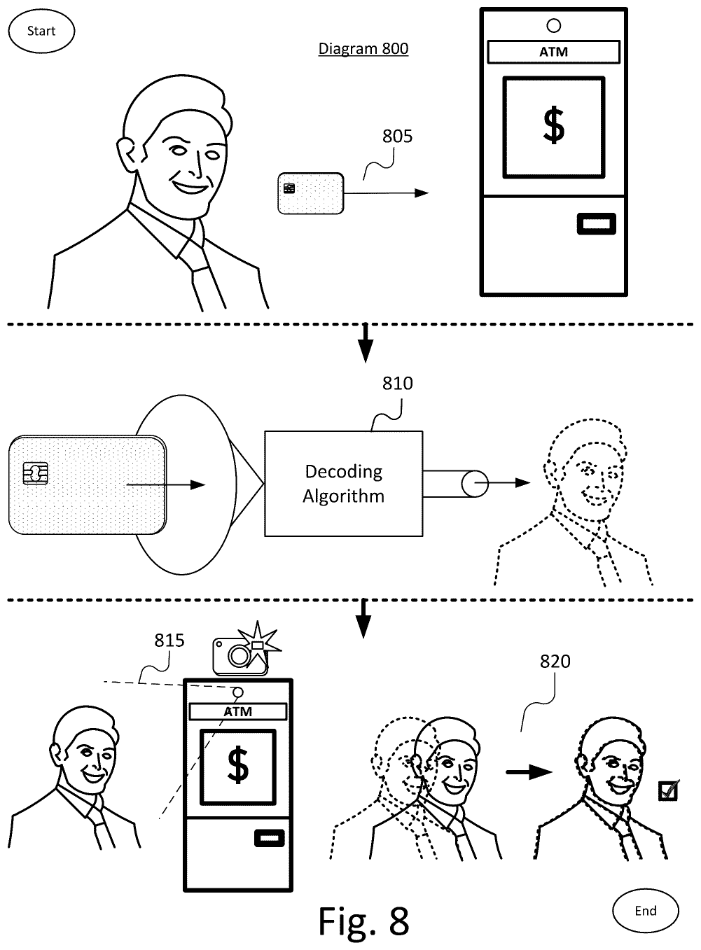

FIG. 8 is a diagram according to an exemplary embodiment.

The diagram 800 illustrates an example embodiment of validating a user's identity with a steganographic card. The diagram 800 operates on the assumption that a user wants to perform a transaction that requires verification of a user's identity.

In action 805, the user inserts a steganographic card into a user device. The user device may be an ATM. The user may want to withdraw cash or otherwise perform a high risk transaction. It is understood that in other example embodiments, the user device can be any other computer-enabled device such as a smart phone or tablet. In other embodiments, the user may scan the steganographic card with a camera-enabled device instead of inserting the card into the ATM.

In action 810, a decoding algorithm within the user device will recognize the biometric data hidden in the steganographic pattern from the card. The biometric data in the diagram 800 is a facial scan. In other embodiments, the biometric data can be iris scans, fingerprint scans, a scalable ratio of facial features associated with the user, hand scans, voice recognitions, and handwriting recognitions. It is understood that these are non-limiting examples and that the biometric data may be one or more combinations of biometric data not listed.

The decoding algorithm can be one or more selected from the group of batch steganography, permutation steganography, least significant bits (LSB), bit-plane complexity segmentation (BPCS), and chaos based spread spectrum image steganography (CSSIS), masking and filtering, redundant pattern encoding, encrypt and scatter, and coding and cosine transformation. The algorithm can be run on a processor. The processor may be a part of the user device or a server.

In action 815, the user attempts to verify their identity by providing a biometric of their own that matches the biometric derived from the steganographic pattern. For example, a camera-enabled user device may take a picture of the user's face to match the facial scan from the steganographic pattern. In other examples, some other user device such as a smart phone may take the picture. In other examples, the biometric data can be iris scans, fingerprint scans, a scalable ratio of facial features associated with the user, hand scans, voice recognitions, and handwriting recognitions.

In action 820, the user device verifies that the user's facial scan matches the facial scan on the steganographic pattern. This action may be performed by a processor. The processor may be a part of the user device or a server. In other examples, the biometric data can be iris scans, fingerprint scans, a scalable ratio of facial features associated with the user, hand scans, voice recognitions, and handwriting recognitions.

Once the user's identity has been verified, the user may proceed with the transaction. For example, the user may withdraw or deposit money into an ATM. As another example, the user may gain access to a secure area like an apartment or storage space.

In some aspects, the techniques described herein relate to a card configured to contain biometric information, the card including: a substrate; and a first face, the first face including a steganographic pattern encoded thereon, wherein the steganographic pattern contains biometric data associated with a user.

In some aspects, the techniques described herein relate to a card, wherein the steganographic pattern contains biometric data associated with multiple users.

In some aspects, the techniques described herein relate to a card, wherein the biometric data further includes at least one selected from a group of facial scans, iris scans, and fingerprint scans.

In some aspects, the techniques described herein relate to a card, wherein the biometric data further includes a three-dimensional facial geometry associated with the user.

In some aspects, the techniques described herein relate to a card, wherein the biometric data further includes a scalable ratio of facial features associated with the user.

In some aspects, the techniques described herein relate to a card, wherein the steganographic pattern includes a reflective ink.

In some aspects, the techniques described herein relate to a card, wherein the steganographic pattern is achieved by at least one selected from the group of chaffing a substrate and winnowing a substrate.

In some aspects, the techniques described herein relate to a system for identity verification, the system including: a card, including: a substrate, and a first face, the first face including an encoded steganographic pattern, wherein the steganographic pattern contains biometric data associated with a user; a user device; and a processor, wherein the processor is configured to: receive a request associated with the card, recognize the biometric data from the steganographic pattern on the card, request verification biometric data from the user associated with the card, receive, by the user device, verification biometric data from the user, and apply an algorithm to determine whether the verification biometric data matches the biometric data contained in the steganographic pattern.

In some aspects, the techniques described herein relate to a system, wherein the steganographic pattern contains biometric data associated with multiple users.

In some aspects, the techniques described herein relate to a system, wherein the user device further includes at least one selected from the group of a cell phone, tablet, and an automated teller machine (ATM).

In some aspects, the techniques described herein relate to a system, wherein the algorithm further includes at least one selected from the group of batch steganography, permutation steganography, least significant bits (LSB), bit-plane complexity segmentation (BPCS), and chaos based spread spectrum image steganography (CSSIS).

In some aspects, the techniques described herein relate to a system, wherein the biometric data further includes a three-dimensional facial geometry associated with the user.

In some aspects, the techniques described herein relate to a system, wherein the biometric data further includes a scalable ratio of facial features associated with the user.

In some aspects, the techniques described herein relate to a system, wherein the steganographic pattern includes a UV sensitive ink.

In some aspects, the techniques described herein relate to a method for identity verification, the method including the steps of: providing a card configured to contain biometric information, the card including: a substrate, and a first face, the first face including a steganographic pattern, wherein the steganographic pattern contains biometric data associated with a user; receiving, by a user device, a request associated with the card; recognizing, by the user device, the biometric data from the steganographic pattern on the card; requesting, by the user device, verification biometric data from the user associated with the card; receiving, by the user device, verification biometric data from the user; and applying, by the user device, an algorithm to determine verification biometric data matches the biometric data contained in the steganographic pattern.

In some aspects, the techniques described herein relate to a method, wherein the steps further include providing a steganographic pattern containing biometric data of multiple users.

In some aspects, the techniques described herein relate to a method, wherein the steps further include providing a user device further including a wearable smart device.

In some aspects, the techniques described herein relate to a method, wherein the biometric data further includes at least one selected from the group of hand scans, voice recognitions, and handwriting recognitions.

In some aspects, the techniques described herein relate to a method, wherein the steps further include providing a processor further configured to request a verification associated with the user multiple times.

In some aspects, the techniques described herein relate to a method, wherein steps further include providing a steganographic pattern further including temperature sensitive ink.

As used herein, the terms “card” or “contactless card” are not limited to a particular type of card. Rather, it is understood that the terms “card” and “contactless card” can refer to a contact-based card, a contactless card, or any other card, unless otherwise indicated. It is further understood that the present disclosure is not limited to cards having a certain purpose (e.g., payment cards, gift cards, identification cards, or membership cards), to cards associated with a particular type of account (e.g., a credit account, a debit account, a membership account), or to cards issued by a particular entity (e.g., a financial institution, a government entity, or a social club). Instead, it is understood that the present disclosure includes cards having any purpose, account association, or issuing entity.

Although embodiments of the present invention have been described herein in the context of a particular implementation in a particular environment for a particular purpose, those skilled in the art will recognize that its usefulness is not limited thereto and that the embodiments of the present invention can be beneficially implemented in other related environments for similar purposes. The invention should therefore not be limited by the above described embodiments, method, and examples, but by all embodiments within the scope and spirit of the invention as claimed.

As used herein, user information, personal information, and sensitive information can include any information relating to the user, such as a private information and non-private information. Private information can include any sensitive data, including financial data (e.g., account information, account balances, account activity), personal information/personally-identifiable information (e.g., social security number, home or work address, birth date, telephone number, email address, passport number, driver's license number), access information (e.g., passwords, security codes, authorization codes, biometric data), and any other information that user may desire to avoid revealing to unauthorized persons. Non-private information can include any data that is publicly known or otherwise not intended to be kept private.

It is further noted that the systems and methods described herein may be tangibly embodied in one or more physical media, such as, but not limited to, a compact disc (CD), a digital versatile disc (DVD), a floppy disk, a hard drive, read only memory (ROM), random access memory (RAM), as well as other physical media capable of data storage. For example, data storage may include random access memory (RAM) and read only memory (ROM), which may be configured to access and store data and information and computer program instructions. Data storage may also include storage media or other suitable type of memory (e.g., such as, for example, RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives, any type of tangible and non-transitory storage medium), where the files that comprise an operating system, application programs including, for example, web browser application, email application and/or other applications, and data files may be stored. The data storage of the network-enabled computer systems may include electronic information, files, and documents stored in various ways, including, for example, a flat file, indexed file, hierarchical database, relational database, such as a database created and maintained with software from, for example, Oracle® Corporation, Microsoft® Excel file, Microsoft® Access file, a solid state storage device, which may include a flash array, a hybrid array, or a server-side product, enterprise storage, which may include online or cloud storage, or any other storage mechanism. Moreover, the figures illustrate various components (e.g., servers, computers, processors, etc.) separately. The functions described as being performed at various components may be performed at other components, and the various components may be combined or separated. Other modifications also may be made.

Further, it is to be understood that the terminology used herein is for the purpose of describing particular embodiments only and is not intended to be limiting. The terms “a” or “an” as used herein, are defined as one or more than one. The term “plurality” as used herein, is defined as two or more than two. The term “another” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “providing” is defined herein in its broadest sense, e.g., bringing/coming into physical existence, making available, and/or supplying to someone or something, in whole or in multiple parts at once or over a period of time. Also, for purposes of description herein, the terms “upper,” “lower,” “left,” “rear,” “right,” “front,” “vertical,” “horizontal,” and derivatives thereof relate to the invention as oriented in the figures and is not to be construed as limiting any feature to be a particular orientation, as said orientation may be changed based on the user's perspective of the device.

In the invention, various embodiments have been described with references to the accompanying drawings. It may, however, be evident that various modifications and changes may be made thereto, and additional embodiments may be implemented, without departing from the broader scope of the invention as set forth in the claims that follow. The invention and drawings are accordingly to be regarded in an illustrative rather than restrictive sense.

The invention is not to be limited in terms of the particular embodiments described herein, which are intended as illustrations of various aspects. Many modifications and variations can be made without departing from its spirit and scope. Functionally equivalent systems, processes and apparatuses within the scope of the invention, in addition to those enumerated herein, may be apparent from the representative descriptions herein. Such modifications and variations are intended to fall within the scope of the appended claims. The invention is to be limited only by the terms of the appended claims, along with the full scope of equivalents to which such representative claims are entitled.

The preceding description of exemplary embodiments provides non-limiting representative examples referencing numerals to particularly describe features and teachings of different aspects of the invention. The embodiments described should be recognized as capable of implementation separately, or in combination, with other embodiments from the description of the embodiments. A person of ordinary skill in the art reviewing the description of embodiments should be able to learn and understand the different described aspects of the invention. The description of embodiments should facilitate understanding of the invention to such an extent that other implementations, not specifically covered but within the knowledge of a person of skill in the art having read the description of embodiments, would be understood to be consistent with an application of the invention.

1. A card configured to contain biometric information, the card comprising:
a substrate; and
a first face, the first face comprising a steganographic pattern encoded thereon,
wherein the steganographic pattern is achieved by at least one selected from the group of chaffing the substrate and winnowing the substrate, and
wherein the steganographic pattern contains biometric data associated with a user.

2. The card of claim 1, wherein the steganographic pattern contains biometric data associated with multiple users.

3. The card of claim 1, wherein the biometric data comprises at least one selected from a group of facial scans, iris scans, and fingerprint scans.

4. The card of claim 1, wherein the biometric data comprises a three-dimensional facial geometry associated with the user.

5. The card of claim 4, wherein the biometric data further comprises a scalable ratio of facial features associated with the user.

6. The card of claim 1, wherein the steganographic pattern comprises a reflective ink.

7. (canceled)

8. A system for identity verification, the system comprising:
a card, comprising:
a substrate, and
a first face, the first face comprising an encoded steganographic pattern achieved by at least one selected from the group of chaffing the substrate and winnowing the substrate, wherein the steganographic pattern contains biometric data associated with a user;
a user device; and
a processor, wherein the processor is configured to:
receive a request associated with the card,
recognize the biometric data from the steganographic pattern on the card,
request verification biometric data from the user associated with the card,
receive, by the user device, verification biometric data from the user, and
apply an algorithm to determine whether the verification biometric data matches the biometric data contained in the steganographic pattern.

9. The system of claim 8, wherein the steganographic pattern contains biometric data associated with multiple users.

10. The system of claim 8, wherein the user device comprises at least one selected from the group of a cell phone, tablet, and an automated teller machine (ATM).

11. The system of claim 8, wherein the algorithm comprises at least one selected from the group of batch steganography, permutation steganography, least significant bits (LSB), bit-plane complexity segmentation (BPCS), and chaos based spread spectrum image steganography (CSSIS).

12. The system of claim 8, wherein the biometric data comprises a three-dimensional facial geometry associated with the user.

13. The system of claim 8, wherein the biometric data comprises a scalable ratio of facial features associated with the user.

14. The system of claim 8, wherein the steganographic pattern comprises a UV sensitive ink.

15. A method for identity verification, the method comprising the steps of:
providing a card configured to contain biometric information, the card comprising:
a substrate, and
a first face, the first face comprising a steganographic pattern achieved by at least one selected from the group of chaffing the substrate and winnowing the substrate, wherein the steganographic pattern contains biometric data associated with a user;
receiving, by a user device, a request associated with the card;
recognizing, by the user device, the biometric data from the steganographic pattern on the card;
requesting, by the user device, verification biometric data from the user associated with the card;
receiving, by the user device, verification biometric data from the user; and
applying, by the user device, an algorithm to determine verification biometric data matches the biometric data contained in the steganographic pattern.

16. The method of claim 15, wherein the steps further comprise providing a steganographic pattern containing biometric data of multiple users.

17. The method of claim 15, wherein the steps further comprise providing a user device further comprising a wearable smart device.

18. The method of claim 15, wherein the biometric data comprises at least one selected from the group of hand scans, voice recognitions, and handwriting recognitions.

19. The method of claim 15, wherein the steps further comprise providing a processor further configured to request a verification associated with the user multiple times.

20. The method of claim 15, wherein steps further comprise providing a steganographic pattern further comprising temperature sensitive ink.

21. The method of claim 15, wherein the algorithm comprises at least one selected from the group of masking and filtering, redundant pattern encoding, encrypt and scatter, chaffing and winnowing, and coding and cosine transformation.
